(19) United States
(12) Patent Application Publication
(10) Pub. No.: US 2019/0103091 A1
(43) Pub. Date: Apr. 4, 2019

(54) METHOD AND APPARATUS FOR TRAINING TEXT NORMALIZATION MODEL, METHOD AND APPARATUS FOR TEXT NORMALIZATION

(71) Applicant: Baidu Online Network Technology (Beijing) Co., Ltd ., Beijing (CN)

(72) Inventor: Hanying CHEN, Beijing (CN)

(21) Appl. No.: 16/054,815

(22) Filed: Aug. 3, 2018

(30) Foreign Application Priority Data
Sep. 29, 2017 (CN) 201710912134.4

(51) Int. Cl. G10L 13/08; G06N 3/04; G06F 17/30; G06F 17/27

(52) U.S. Cl. CPC G10L 13/08; G06F 17/2785; G06F 17/30705; G06N 3/04

(57) ABSTRACT

The disclosure discloses a method and apparatus for training a text normalization model, and a method and apparatus for text normalization. One method includes: inputting input characters in an input character sequence corresponding to an input text into a recurrent neural network corresponding to a text normalization model successively, the input character sequence being generated by segmenting the input text according to a first preset granularity to obtain a first segmentation result and tagging a non-word character having at least two normalization results to obtain the input character sequence; classifying each of the input characters by the recurrent neural network to obtain a predicted classification result of the input character sequence; and adjusting a parameter of the recurrent neural network based on the difference between the predicted classification result of the input character sequence and a tagged classification result of a normalized text of the input text.

### CROSS-REFERENCE TO RELATED APPLICATIONS

This application claims priority to Chinese Patent Application no. 201710912134.4, filed with the State Intellectual Property Office of the People's Republic of China (SIPO) on Sep. 29, 2017, the content of which is incorporated herein by reference in its entirety.

### TECHNICAL FIELD

The embodiments of the present disclosure relate to the field of computer technology, particularly relate to the field of speech synthesis, in particular to a method and apparatus for training a text normalization model, and a method and apparatus for text normalization.

### BACKGROUND

Artificial Intelligence (AI) is a new technical science that researches and develops theories, methods, technologies, and application systems for simulating, extending, and expanding human intelligence. Artificial Intelligence is a branch of the computer science, and attempts to understand the essence of intelligence and produce a new intelligent machine that is capable of responding in a similar way to human intelligence. Research in such a field includes robots, speech recognition, image recognition, natural language processing, and expert systems. The speech synthesis is an important direction in the computer science field and the Artificial Intelligence field.

Speech synthesis is a technology that generates artificial speech by means of mechanical and electronic methods. TTS (Text to speech) technology belongs to the speech synthesis, and is a technology that converts computer-generated or externally input text information into intelligible fluent oral output. Text normalization is the key technology in the speech synthesis, and is a process of converting nonstandard characters in a text into standard characters.

Most of the existing text normalization methods are based on rules. Some conversion rules from nonstandard characters to standard characters are set on the basis of the observation and statistics on the corpus. However, with the increase of TTS requests and the diversity change of texts, the number of rules is gradually increasing, and the maintenance of rules is becoming increasingly difficult, which are not conducive to saving resources.

### SUMMARY

The embodiments of the present disclosure provide a method and apparatus for training a text normalization model, and a method and apparatus for text normalization.

In a first aspect, the embodiment of the present disclosure provides a method for training a text normalization model, including: inputting input characters in an input character sequence corresponding to an input text into a recurrent neural network corresponding to a to-be-generated text normalization model successively; classifying each of the input characters by the recurrent neural network to obtain a predicted classification result of the input character sequence; and adjusting a parameter of the recurrent neural network based on the difference between the predicted classification result of the input character sequence and a tagged classification result of a normalized text of the input text, wherein the input character sequence corresponding to the input text is generated by segmenting the input text according to a first preset granularity to obtain a first segmentation result, and tagging a non-word character having at least two normalization results in the first segmentation result to obtain the input character sequence.

In some embodiments, the non-word character having at least two normalization results in the first segmentation result includes at least one of: a symbol character having at least two normalization results, a multi-digit number character having at least two normalization results, or a letter character having at least two normalization results. At this time, the non-word character having at least two normalization results in the first segmentation result is tagged by: replacing the symbol character having at least two normalization results in the first segmentation result with a pronunciation type tag of the symbol character, replacing the multi-digit number character having at least two normalization results in the first segmentation result with a tag corresponding to the semantic type of the multi-digit number character and including length information of the multi-digit number character, and replacing the letter character having at least two normalization results in the first segmentation result with a tag corresponding to the semantic type of the letter character.

In some embodiments, the predicted classification result of the input character sequence includes predicted category information of the each of the input characters in the input character sequence; and the tagged classification result of the normalized text of the input text includes tagged category information of each target character in a target character sequence corresponding to the normalized text of the input text.

In some embodiments, the tagged classification result of the normalized text of the input text is generated by: segmenting the normalized text of the input text according to a second preset granularity to obtain a second segmentation result, the second segmentation result including at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text; replacing the single word character corresponding to the single word character in the input text, the symbol character corresponding to the symbol character in the input text, and the letter character corresponding to the letter character in the input text in the second segmentation result with a first preset category identifier; replacing the first word character string corresponding to the multi-digit number character in the input text in the second segmentation result with a first semantic category identifier for identifying the semantic type of the corresponding multi-digit number character in the input text; replacing the second word character string corresponding to the symbol character in the input text in the second segmentation result with a second semantic category identifier for identifying the semantic type of the corresponding symbol character in the input text; and replacing the third word character string corresponding to the letter character in the input text with a third semantic category identifier for identifying the semantic type of the corresponding letter character in the input text.

In a second aspect, the embodiment of the present disclosure provides a method for text normalization, including: acquiring a to-be-processed character sequence that is obtained by segmenting a to-be-processed text according to a first preset granularity and tagging a non-word character having at least two normalization results in a segmentation result; inputting the to-be-processed character sequence into a trained text normalization model to obtain an output category identifier sequence; and converting output category identifiers in the output category identifier sequence on the basis of the to-be-processed character sequence to obtain output characters corresponding to the output category identifiers, and combining the output characters in sequence to obtain a normalized text of the to-be-processed text, wherein the text normalization model is trained on the basis of the method according to the first aspect.

In some embodiments, the non-word character having at least two normalization results in the segmentation result includes at least one of: a symbol character having at least two normalization results, a multi-digit number character having at least two normalization results, or a letter character having at least two normalization results; the non-word character having at least two normalization results in the segmentation result is tagged by: replacing the symbol character having at least two normalization results in the segmentation result with a pronunciation type tag of the symbol character, replacing the multi-digit number character having at least two normalization results in the segmentation result with a tag corresponding to the semantic type of the multi-digit number character and including length information of the multi-digit number character, and replacing the letter character having at least two normalization results in the segmentation result with a tag corresponding to the semantic type of the letter character.

In some embodiments, the output category identifiers in the output category identifier sequence include at least one of: a first preset category identifier for identifying the category of an unconverted character, a first semantic category identifier for identifying the semantic type of a multi-digit number character, a second semantic category identifier for identifying the semantic type of a symbol character, or a third semantic category identifier for identifying the semantic type of a letter character. At this time, the converting output category identifiers in the output category identifier sequence on the basis of the to-be-processed character sequence to obtain output characters corresponding to the output category identifiers includes: replacing the first preset category identifier with a corresponding to-be-processed character; determining the semantic type of a corresponding multi-digit number character in the to-be-processed character sequence according to the first semantic category identifier, and converting the multi-digit number character into a corresponding word character string according to the semantic type of the multi-digit number character; determining the semantic type of a corresponding symbol character in the to-be-processed character sequence according to the second semantic category identifier, and converting the symbol character into a corresponding word character string according to the semantic type of the symbol character; and determining the semantic type of a corresponding letter character in the to-be-processed character sequence according to the third semantic category identifier, and converting the letter character into a corresponding word character string according to the semantic type of the letter character.

In a third aspect, the embodiment of the present disclosure provides an apparatus for training a text normalization model, including: an input unit, configured for inputting input characters in an input character sequence corresponding to an input text into a recurrent neural network corresponding to a to-be-generated text normalization model successively; a prediction unit, configured for classifying each of the input characters by the recurrent neural network to obtain a predicted classification result of the input character sequence; and an adjustment unit, configured for adjusting a parameter of the recurrent neural network based on the difference between the predicted classification result of the input character sequence and a tagged classification result of a normalized text of the input text, wherein the input character sequence corresponding to the input text is generated by segmenting the input text according to a first preset granularity to obtain a first segmentation result, and tagging a non-word character having at least two normalization results in the first segmentation result to obtain the input character sequence.

In some embodiments, the non-word character having at least two normalization results in the first segmentation result includes at least one of: a symbol character having at least two normalization results, a multi-digit number character having at least two normalization results, or a letter character having at least two normalization results. At this time, the non-word character having at least two normalization results in the first segmentation result is tagged by: replacing the symbol character having at least two normalization results in the first segmentation result with a pronunciation type tag of the symbol character, replacing the multi-digit number character having at least two normalization results in the first segmentation result with a tag corresponding to the semantic type of the multi-digit number character and including length information of the multi-digit number character, and replacing the letter character having at least two normalization results in the first segmentation result with a tag corresponding to the semantic type of the letter character.

In some embodiments, the predicted classification result of the input character sequence includes predicted category information of the each of the input characters in the input character sequence; and the tagged classification result of the normalized text of the input text includes tagged category information of each target character in a target character sequence corresponding to the normalized text of the input text.

In some embodiments, the tagged classification result of the normalized text of the input text is generated by: segmenting the normalized text of the input text according to a second preset granularity to obtain a second segmentation result, the second segmentation result including at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text; replacing the single word character corresponding to the single word character in the input text, the symbol character corresponding to the symbol character in the input text, and the letter character corresponding to the letter character in the input text in the second segmentation result with a first preset category identifier; replacing the first word character string corresponding to the multi-digit number character in the input text in the second segmentation result with a first semantic category identifier for identifying the semantic type of the corresponding multi-digit number character in the input text; replacing the second word character string corresponding to the symbol character in the input text in the second segmentation result with a second semantic category identifier for identifying the semantic type of the corresponding symbol character in the input text; and replacing the third word character string corresponding to the letter character in the input text with a third semantic category identifier for identifying the semantic type of the corresponding letter character in the input text.

In a fourth aspect, the embodiment of the present disclosure provides an apparatus for text normalization, including: an acquisition unit, configured for acquiring a to-be-processed character sequence that is obtained by segmenting a to-be-processed text according to a first preset granularity and tagging a non-word character having at least two normalization results in a segmentation result; a classification unit, configured for inputting the to-be-processed character sequence into a trained text normalization model to obtain an output category identifier sequence; and a processing unit, configured for converting output category identifiers in the output category identifier sequence on the basis of the to-be-processed character sequence to obtain output characters corresponding to the output category identifiers, and combining the output characters in sequence to obtain a normalized text of the to-be-processed text, wherein the text normalization model is trained on the basis of the method according to the first aspect.

In some embodiments, the non-word character having at least two normalization results in the segmentation result includes at least one of: a symbol character having at least two normalization results, a multi-digit number character having at least two normalization results, or a letter character having at least two normalization results. At this time, the non-word character having at least two normalization results in the segmentation result is tagged by: replacing the symbol character having at least two normalization results in the segmentation result with a pronunciation type tag of the symbol character, replacing the multi-digit number character having at least two normalization results in the segmentation result with a tag corresponding to the semantic type of the multi-digit number character and including length information of the multi-digit number character, and replacing the letter character having at least two normalization results in the segmentation result with a tag corresponding to the semantic type of the letter character.

In some embodiments, the output category identifiers in the output category identifier sequence include at least one of: a first preset category identifier for identifying the category of an unconverted character, a first semantic category identifier for identifying the semantic type of a multi-digit number character, a second semantic category identifier for identifying the semantic type of a symbol character, or a third semantic category identifier for identifying the semantic type of a letter character. At this time, the processing unit is further configured for converting output category identifiers in the output category identifier sequence to obtain output characters corresponding to the output category identifiers by: replacing the first preset category identifier with a corresponding to-be-processed character; determining the semantic type of a corresponding multi-digit number character in the to-be-processed character sequence according to the first semantic category identifier, and converting the multi-digit number character into a corresponding word character string according to the semantic type of the multi-digit number character; determining the semantic type of a corresponding symbol character in the to-be-processed character sequence according to the second semantic category identifier, and converting the symbol character into a corresponding word character string according to the semantic type of the symbol character; and determining the semantic type of a corresponding letter character in the to-be-processed character sequence according to the third semantic category identifier, and converting the letter character into a corresponding word character string according to the semantic type of the letter character.

The method and apparatus for training a text normalization model according to the embodiments of the present disclosure convert special texts possibly having multiple different normalization results in an input text into corresponding type tags for training, thereby solving the problem of difficult rule maintenance and ensuring that a text normalization model obtained by the training accurately converts such special texts by: inputting input characters in an input character sequence corresponding to an input text into a recurrent neural network corresponding to a to-be-generated text normalization model successively; classifying each of the input characters with a first preset category identifier by the recurrent neural network with a first preset category identifier to obtain a predicted classification result of the input character sequence with a first preset category identifier; and adjusting a parameter of the recurrent neural network with a first preset category identifier based on the difference between the predicted classification result of the input character sequence with a first preset category identifier and a tagged classification result of a normalized text of the input text with a first preset category identifier, wherein the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier.

In the method and apparatus for text normalization, the method includes: first, acquiring a to-be-processed character sequence that is obtained by segmenting a to-be-processed text according to a first preset granularity and tagging a non-word character having at least two normalization results in a segmentation result; secondly, inputting the to-be-processed character sequence into a trained text normalization model to obtain an output category identifier sequence; and converting output category identifiers in the output category identifier sequence on the basis of the to-be-processed character sequence to obtain output characters corresponding to the output category identifiers, and combining the output characters in sequence to obtain a normalized text of the to-be-processed text, wherein the text normalization model is trained by: inputting input characters in an input character sequence corresponding to an input text into a recurrent neural network corresponding to a to-be-generated text normalization model successively; classifying each of the input characters with a first preset category identifier by the recurrent neural network with a first preset category identifier to obtain a predicted classification result of the input character sequence with a first preset category identifier; and adjusting a parameter of the recurrent neural network with a first preset category identifier based on the difference between the predicted classification result of the input character sequence with a first preset category identifier and a tagged classification result of a normalized text of the input text with a first preset category identifier, wherein the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier. The text normalization method needs no rule maintenance, which avoids the resource consumption caused by rule maintenance. In addition, the method has strong flexibility and high accuracy, and may be applied for converting complex texts.

### BRIEF DESCRIPTION OF THE DRAWINGS

Other features, objects, and advantages of the present disclosure will become more apparent by reading the detailed description about the non-limiting embodiments with reference to the following drawings:

FIG. 1 is an exemplary system architecture to which the present disclosure may be applied;

FIG. 2 is a flow diagram of an embodiment of a method for training a text normalization model according to the present disclosure;

FIG. 3 is a flow diagram of an embodiment of a method for text normalization according to the present disclosure;

FIG. 4 is a structural diagram of an embodiment of an apparatus for training a text normalization model according to the present disclosure;

FIG. 5 is a structural diagram of an embodiment of an apparatus for text normalization according to the present disclosure; and

FIG. 6 is a structural diagram of a computer system of a server or a terminal device for realizing the embodiments of the present disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

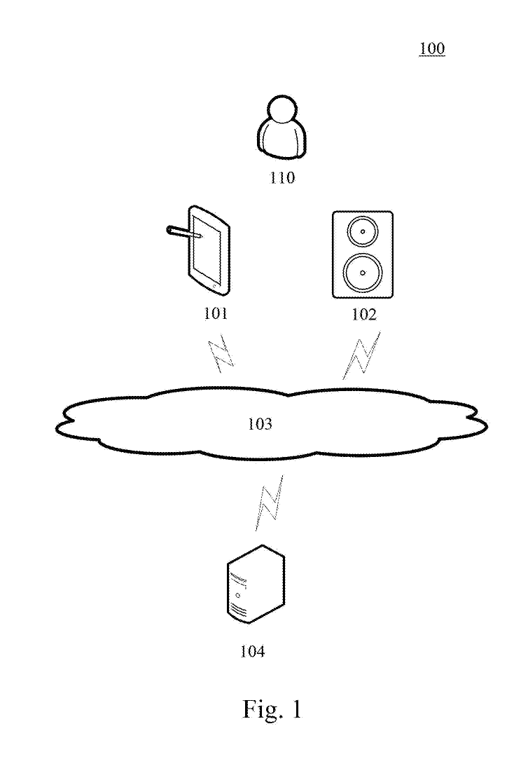

FIG. 1 shows an illustrative architecture of a system 100 which may be used by a method and apparatus for training a text normalization model, and a method and apparatus for text normalization according to the embodiments of the present application.

As shown in FIG. 1, the system architecture 100 may include terminal devices 101 and 102, a network 103 and a server 104. The network 103 serves as a medium providing a communication link between the terminal devices 101 and 102 and the server 104. The network 103 may include various types of connections, such as wired or wireless transmission links, or optical fibers.

The user 110 may use the terminal devices 101 and 102 to interact with the server 104 through the network 103, in order to transmit or receive messages, etc. Various voice interaction applications may be installed on the terminal devices 101 and 102.

The terminal devices 101 and 102 may be various electronic devices with audio input and audio output interfaces and capable of assessing the Internet, including but not limited to, smart phones, tablet computers, smart watches, e-book readers, and smart speakers.

The server 104 may be a voice server providing support for voice services. The voice server may receive voice interaction requests from the terminal devices 101 and 102 and parse the voice interaction requests, and then search for the corresponding text service data, and perform text normalization on the text service data to generate response data and return the generated response data to the terminal devices 101 and 102.

It should be noted that the method for training a text normalization model and the method for text normalization according to the embodiments of the present application may be executed by the terminal devices 101 and 102, or the server 104. Accordingly, the apparatus for training a text normalization model and the apparatus for text normalization may be installed on the terminal devices 101 and 102, or the server 104.

It should be appreciated that the numbers of the terminal devices, the networks and the servers in FIG. 1 are merely illustrative. Any number of terminal devices, networks and servers may be provided based on the actual requirements.

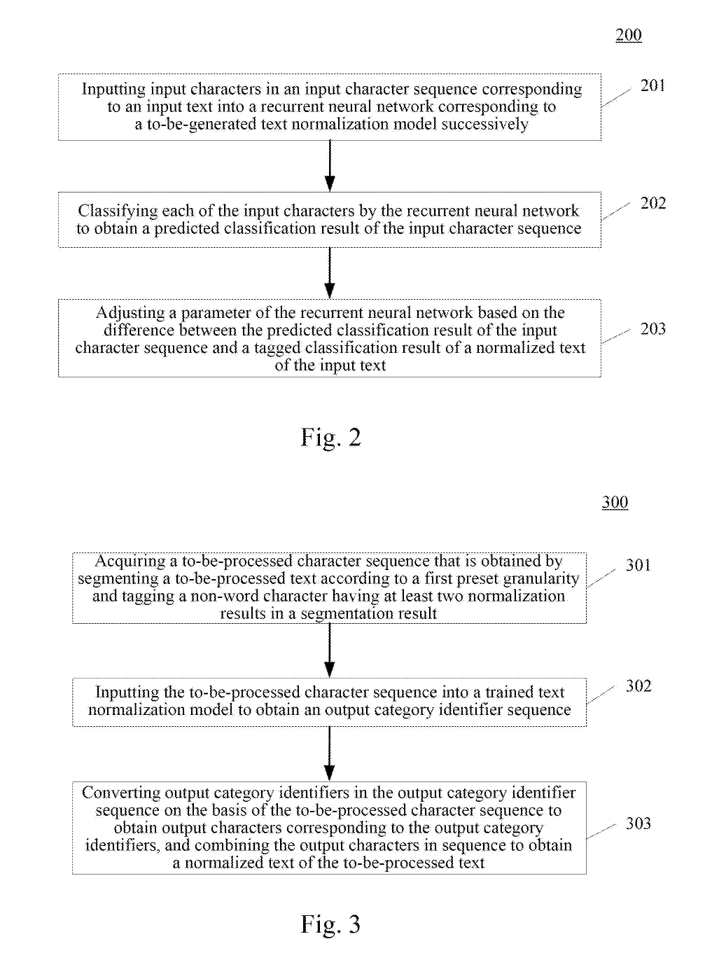

Reference is further made to FIG. 2 that shows a flow 200 of an embodiment of a method for training a text normalization model according to the present disclosure. The method for training a text normalization model includes the following steps:

Step 201, inputting input characters in an input character sequence corresponding to an input text into a recurrent neural network corresponding to a to-be-generated text normalization model successively.

In the present embodiment, an electronic device (the server shown in FIG. 1, for example) on which the method for training a normalization model is applied may obtain a corresponding input character sequence obtained by processing the input text. The input character sequence may include a plurality of characters sequentially arranged from front to back in the input text. The input characters in the obtained input character sequence may be sequentially inputted into a recurrent neural network (RNN) corresponding to a to-be-generated text normalization model.

The input character sequence corresponding to the input text may be generated by segmenting the input text according to a first preset granularity to obtain a first segmentation result, and tagging a non-word character having at least two normalization results in the first segmentation result to obtain the input character sequence.

The input text may be a character text including character types such as words, letters, symbols and Arabic digits. The first preset granularity may be the smallest unit for dividing characters in the input text. The first preset granularity may be set according to the character length. For example, the first preset granularity may be one character length, including a single character, and the single character may include a single word, a single letter, a single symbol, and a single Arabic digit. The first preset granularity may also be set in combination with the character type and character length, such as a single word, a single symbol, a string of multiple digits, and a string of multiple letters. Optionally, the first preset intensity may include a single word, a single symbol, a multi-digit number, and a multi-letter string. After the input text is segmented according to the first preset granularity, a first segmentation result is obtained, and the first segmentation result may be sequentially arranged characters.

The first segmentation result may include a word character, a non-word character having one normalization result, and a non-word character having at least two normalization results. Among them, the non-word character having one normalization result may be, for example, a comma “,”, a semicolon “;”, and a bracket “or”). The non-word character having at least two normalization results may include a symbolic character such as colon “:”, and a letter character such as “W”. For example, the normalization result of the colon “:” may include “to” (sccore) and “* past *” (time), and the normalization results of “W” may include “W” (letter, “tungsten” (metal), and “watt” (power).

After the first segmentation result is obtained, the non-word character having at least two normalization results in the first segmentation result may be tagged, that is, the non-word character having at least two normalization results in the first segmentation result may be replaced w it a corresponding tag, or a corresponding tag may be added at the specific position of the non-word character. Specifically, the non-word character having at least two normalization results may be replaced with a corresponding tag, or a corresponding tag may be added at the specific position of the non-word character according to different character types of the non-word character having at least two normalization results in the first segmentation result. A tag corresponding to each non-word character having at least two normalization results may be predefined. For example, a number or a symbol may be replaced with a corresponding tag according to its semantic and pronunciation type, and different letters may be replaced with a given letter tag.

The input text may be segmented according to a first preset granularity in advance by tag staff to obtain a first segmentation result, and the non-word character having at least two normalization results in the first segmentation result may be replaced with a corresponding tag by the tag staff according to its corresponding type (including a semantic type and a pronunciation type). Alternatively, the electronic device may segment the input text according to a first preset granularity to obtain a first segmentation result, then extract the non-word character having at least two normalization results from the input text. Then, the tag staff may replace the extracted non-word character having at least two normalization results with a tag corresponding to its semantic type or pronunciation type according to its semantic type or pronunciation type.

In some alternative implementations, the input text may be segmented according to the granularity of a single word character, a single symbol, a multi-digit number and a single letter. The non-word character having at least two normalization results in the segmentation result may include at least one of: a symbol character having at least two normalization results, a multi-digit number character having at least two normalization results, or a letter character having at least two normalization results. The non-word character having at least two normalization results in the first segmentation result may be tagged by: replacing the symbol character having at least two normalization results in the first segmentation result with a pronunciation type tag of the symbol character, replacing the multi-digit number character having at least two normalization results in the first segmentation result with a tag corresponding to the semantic type of the multi-digit number character and including length information of the multi-digit number character, and replacing the letter character having at least two normalization results in the first segmentation result with a tag corresponding to the semantic type of the letter character. As an example, the pronunciation type tag of the symbol character “*” having at least two normalization results may be <FH_*_A> or <FH_*_B>. A tag corresponding to the semantic type of the multi-digit number character “100” having at least two normalization results and including the length information of such multi-digit number character may be <INT_L3_T> or <INT_L3_S>, where L3 indicates that the length of the multi-digit number character is 3. A tag corresponding to the semantic type of the letter character “X” having at least two normalization results may be <ZM_X_A> or <ZM_X_B>.

Table 1 shows an example of a result of segmenting an input text according to a first preset granularity and tagging the non-word character having at least two normalization results in the first segmentation result.

TABLE 1
First segmentation result and tagging result of the input text

| | |
|---|---|
| Input text | A venture capital fund of 100 billion yen |
| | (about 1.09 billion dollar) is provided additionally |
| First | A \| venture \| capital \| fund \| of \| 100 \| |
| segmentation | billion \| yen \| (\| about \| 1 \| . \| 09 \| |
| result | billion \| dollar \|) \| is \| provided \| additionally |
| Tagging result | A \| venture \| capital \| fund \| of \| <INT_L3_T> |
| | \| billion \| yen \| (\| about \| 1 \| . \| |
| | <INT_L2_0_9> \| billion \| dollar \|) \| is \| |
| | provided \| additionally |

By tagging a non-word character possibly having at least two different normalization results, the method for training a text normalization model according to the present embodiment improves the generalization of the model and may be applied for processing complex texts.

Step 202: classifying each of the input characters by the recurrent neural network to obtain a predicted classification result of the input character sequence.

In the present embodiment, the recurrent neural network corresponding to the to-be-generated text normalization model may be used to predict each of the input characters sequentially inputted to obtain a predicted classification result of the each input character.

In the present embodiment, the recurrent neural network may include an input layer, a hidden layer, and an output layer. The input character sequence x₁, x₂, x₃ . . . . X_{Ts} (Ts is the sequence length, or the number of input characters in an input character sequence) may be inputted into the input layer of the recurrent neural network. Assuming that xₜ represents the input in step t, the input character xₜ is subject to nonlinear conversion as shown in formula (1) to obtain the state sₜ of the hidden layer:

sₜ=ƒ(xₜ,sₜ₋₁)=Uxₜ+Wsₜ₋₁, (1)

Where, ƒ is a nonlinear activation function, which may be, for example, a tan h function; U and W are parameters in the nonlinear activation function, t=1, 2, 3 . . . . Tₛ; and s₀ may be 0.

Assuming that the output sequence of a decoder is y₁, y₂, y₃ . . . , the output yₜ (which is the predicted classification result of xₜ) of the output layer in step t is as follows:

yₜ=g(sₜ)=Vsₜ+c, (2)

Where, the formula (2) means nonlinear conversion on the state sₜ, wherein V and c are conversion parameters, and optionally, the nonlinear conversion function may be softmax.

As may be seen from the formula (1), the state of the hidden layer in step t is related to the state in step t−1 and the currently input character xₜ, then the training process of the text normalization model may capture the context information accurately to predict the category of the current character.

Step 203: adjusting a parameter of the recurrent neural network based on the difference between the predicted classification result of the input character sequence and a tagged classification result of a normalized text of the input text.

After the predicted result of the input character sequence is obtained, such a result may be compared with a tagged classification result of the normalized text of the input text, the difference therebetween is calculated, and then a parameter of the recurrent neural network is adjusted based on the difference.

Specifically, when the text normalization model is trained, the classification result corresponding to the normalization on the input text may be tagged as tagged sample data. The tagging result of the normalized text of the input text may be a manually tagged classification result of each character in the normalized text of the input text. After the recurrent neural network corresponding to the text normalization model predicts the input text to obtain a predicted classification result, great difference between the predicted classification result and the tagged classification result indicates that the accuracy of the recurrent neural network needs to be improved. At this time, the parameter of the recurrent neural network may be adjusted. The parameter of the recurrent neural network may specifically include the parameters U and W in the nonlinear activation function ƒ and the parameters V and c in the nonlinear conversion function g.

Further, the difference between the predicted classification result and the tagged classification result may be expressed by a loss function, then the gradient of the loss function with respect to each parameter in the recurrent neural network is calculated. The each parameter is updated by using a gradient descent method, the input character sequence is re-inputted into the recurrent neural network with an updated parameter to obtain a new predicted classification result, and then the step of updating the parameter is repeated till the loss function meets a preset convergence condition. At this time, the training result of the recurrent neural network, namely the text normalization model, is obtained.

In some alternative implementations of the present embodiment, the predicted classification result of the input character sequence may include predicted category information of the each of the input characters in the input character sequence; and the tagged classification result of the normalized text of the input text includes tagged category information of each target character in a target character sequence corresponding to the normalized text of the input text. The category information here may be expressed with a category identifier.

For example, the categories of a word character and a non-word character having only one normalization result are unconverted categories and may be expressed by a preset category identifier “E”. The non-word character having at least two normalization results may be classified according to corresponding different normalization results. For example, the category corresponding to the multi-digit number character “100” may include a numerical value category, a written number category and an oral number category. The numerical value category corresponds to the normalization result “one hundred” and may be identified by the category tag <INT_L3_A>, and the written number category and the oral number category respectively correspond to the normalization results “one zero zero” and “one double zero.” For another example, the category corresponding to the symbol “:” may include a punctuation category, a score category, and a time category, and the category corresponding to the letter “W” may include a letter category, an element category and a power unit category.

Training sample data of the to-be-generated text normalization model may include an input text and a normalized text of the input text. In a further embodiment, the tagged classification result of the normalized text of the input text is generated by: first, segmenting the normalized text of the input text according to a second preset granularity to obtain a second segmentation result. The second preset granularity here may correspond to the first preset granularity, and the second segmentation result of the normalized text of the input text may correspond to the first segmentation result of the input text.

The second segmentation result includes at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text.

And then, the single word character corresponding to the single word character in the input text, the symbol character corresponding to the symbol character in the input text, and the letter character corresponding to the letter character in the input text in the second segmentation may be replaced with a first preset category identifier; the first word character string corresponding to the multi-digit number character in the input text in the second segmentation result may be replaced with a first semantic category identifier for identifying the semantic type of the corresponding multi-digit number character in the input text; the second word character string corresponding to the symbol character in the input text in the second segmentation result may be replaced with a second semantic category identifier for identifying the semantic type of the corresponding symbol character in the input text; and the third word character string corresponding to the letter character in the input text may be replaced with a third semantic category identifier for identifying the semantic type of the corresponding letter character in the input text. Different semantic category identifiers may be represented by different identifiers (for example, different English letters, different numbers, different combinations of English letters and numbers/symbols).

Table 2 shows an example of processing the normalized text “A venture capital fund of one hundred billion yen (about one point zero nine billion dollar) is provided additionally” corresponding to the input text “A venture capital fund of 100 billion yen (about 1.09 billion dollar) is provided additionally” in Table 1 to obtain a corresponding output character sequence.

TABLE 2
Results of processing normalized text corresponding
to input text to obtain output character sequence

| | |
|---|---|
| Normalized | A venture capital fund of one hundred billion |
| text | yen (about one point zero nine billion |
| | dollar) is provided additionally |
| Second | A \| venture \| capital \| fund \| of \| one hundred |
| segmentation | \| billion \| yen \| (\| about \| one \| point \| |
| result | zero nine \| billion \| dollar \|) \| is \| |
| | provided \| additionally |
| Output | E \| E \| E \| E \| E \| A \| E \| E \| E \| E \| E \| |
| character | E \| D \| E \| E \| E \| E \| E \| E |
| sequence | |

A and D are category identifiers for identifying the semantic type of the characters “one hundred” and “zero nine” that are corresponding to the multi-digit numbers “100” and “09” in the second segmentation result respectively, and E is the first preset category identifier for identifying the category of the characters that are not converted in the second segmentation-result.

As may be seen from Table 1 and Table 2, multi-digit numbers, characters and English letters in the input text are replaced with tags, and multi-digit numbers, characters, and multi-letter strings in the output character sequence are replaced with corresponding semantic category identifiers. In this way, the text normalization model easily learn the classification logic of non-word characters during the training process, which may improve the accuracy of the text normalization model. In addition, the method for training a text normalization model according to the present embodiment may accurately identify the semantic types of the non-word character having at least two normalization results by means of the generalization processing of tagging the input text as a training sample and replacing the normalized text of the input text with a category identifier, thus improving the accuracy of the text normalization model.

The method for training a text normalization model according to the embodiment of the present disclosure converts special texts possibly having multiple different normalization results in an input text into corresponding category tags and train based on a tagged classification result, thereby solving the problem of difficult rule maintenance and ensuring that a text normalization model obtained by training accurately determines the semantic types of these special texts to accurately convert the same by: inputting input characters in an input character sequence corresponding to an input text into a recurrent neural network corresponding to a to-be-generated text normalization model successively; classifying each of the input characters with a first preset category identifier by the recurrent neural network with a first preset category identifier to obtain a predicted classification result of the input character sequence with a first preset category identifier; and adjusting a parameter of the recurrent neural network with a first preset category identifier based on the difference between the predicted classification result of the input character sequence with a first preset category identifier and a tagged classification result of a normalized text of the input text with a first preset category identifier, where the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier.

Reference is made to FIG. 3 that shows a flow chart of an embodiment of a method for text normalization according to the present disclosure. As shown in FIG. 3, a flow 300 of the method for text normalization according to the present embodiment may include the following steps:

Step 301: acquiring a to-be-processed character sequence that is obtained by segmenting a to-be-processed text according to a first preset granularity and tagging a non-word character having at least two normalization results in a segmentation result.

In the present embodiment, the first preset granularity may be, for example, a single word, a single symbol, a multi-digit number, and a multi-letter string. A to-be-processed text may be segmented according to a first preset granularity, and the to-be-processed text may be divided into a sequence containing only characters having only one normalization result and non-word characters having at least two normalization results. Then the non-word character having at least two normalization results in the segmentation result may be tagged. For example, the non-word character having at least two normalization results may be replaced by a tag corresponding to its semantic type, or a tag corresponding to its semantic type may be added at the specific position of the non-word character having at least two normalization results. Then the characters having only one normalization result and the tagged characters are arranged in the order of each character in the to-be-processed text to obtain a to-be-processed character sequence.

An electronic device to which the method for text normalization is applied may acquire the to-be-processed character sequence. In the present embodiment, the to-be-processed character sequence is obtained by segmenting and tagging the to-be-processed text by tag staff. Then the electronic device may obtain the to-be-processed character sequence inputted by the tag staff by means of an input interface.

In some alternative implementations of the present embodiment, the non-word character having at least two normalization results that is obtained by segmenting the to-be-processed text may include at least one of: a symbol character having at least two normalization results, a multi-digit number character having at least two normalization results, or a letter character having at least two normalization results. The non-word character having at least two normalization results in the segmentation result may be tagged by: replacing the symbol character having at least two normalization results in the segmentation result with a pronunciation type tag of the symbol character, replacing the multi-digit number character having at least two normalization results in the segmentation result with a tag corresponding to the semantic type of the multi-digit number character and including length information of the multi-digit number character, and replacing the letter character having at least two normalization results in the segmentation result with a tag corresponding to the semantic type of the letter character.

As an example, the to-be-processed text is “Federer won the match with a score of 3:1, and he issued 11 aces in this match,” which includes the symbol, character “:” having at least two different normalization results, and the multi-digit number character “11” having at least two different normalization results. The to-be-processed text may be segmented according to the granularity of a single word character, a single symbol, a multi-digit number, and a multi-letter string. The pronunciation of the symbol character “:” is the pronunciation of “to,” which may be replaced with the tag <lab1_A> of its pronunciation type, and the multi-digit number character “11” may be replaced with the tag <lab2_C> of its semantic type “numerical value.”

Step 302: inputting the to-be-processed character sequence into a trained text normalization model to obtain an output category identifier sequence.

In the present embodiment, the text normalization model may be trained on the basis of the method described above in connection with FIG. 2. Specifically, when the text normalization model is trained, the input text and the normalized text corresponding to the input text are provided as the original training samples. Input characters in an input character sequence corresponding to the input text may be sequentially inputted into a recurrent neural network corresponding to a to-be-generated text normalization model; then each of the input characters is classified by the recurrent neural network to obtain a predicted classification result of the input character sequence; finally, a parameter of the recurrent neural network is adjusted based on the difference between the predicted classification result of the input character sequence and a tagged classification result of the normalized text of the input text. The input character sequence corresponding to the input text is generated by segmenting the input text according to a first preset granularity to obtain a first segmentation result, and tagging a non-word character having at least two normalization results in the first segmentation result to obtain an input character sequence.

It may be seen that the to-be-processed character sequence obtained in step 301 according to the present embodiment and the input character sequence in the method for training a text normalization model are respectively obtained by the same segmentation and tagging on the input text for training and the to-be-processed text, then the to-be-processed character sequence is in the same form as that of the input character sequence in the method for training a text normalization model.

After the to-be-processed character sequence is inputted into the text normalization model for processing, an output category identifier sequence corresponding to the to-be-processed character sequence may be output. The output category identifier sequence may include category identifiers corresponding to the to-be-processed characters in the to-be-processed character sequence.

Step 303: converting output category identifiers in the output category identifier sequence on the basis of the to-be-processed character sequence to obtain output characters corresponding to the output category identifiers, and combining the output characters in sequence to obtain a normalized text of the to-be-processed text.

The output category identifiers in the output category identifier sequence may be replaced with corresponding output characters in combination with the characters in the to-be-processed character sequence. For example, if the English letter in the to-be-processed character sequence is “W” and the output category identifier is the category identifier of power unit, the output category identifier may be converted into a corresponding word character “watt.”

Then, a normalized text of the to-be-processed text may be obtained by sequentially combining the converted output characters according to the output order of the recurrent neural network model.

In some alternative implementations of the present embodiment, the output category identifier in the output category identifier sequence may include at least one of: a first preset category identifier for identifying the category of an unconverted character, a first semantic category identifier for identifying the semantic type of a multi-digit number character, a second semantic category identifier for identifying the semantic type of a symbol character, or a third semantic category identifier for identifying the semantic type of a letter character. At this time, the converting output category identifiers in the output category identifier sequence on the basis of the to-be-processed character sequence to obtain output characters corresponding to the output category identifiers may include: replacing the first preset category identifier with a corresponding to-be-processed character; determining the semantic type of a corresponding multi-digit number character in the to-be-processed character sequence according to the first semantic category identifier, and converting the multi-digit number character into a corresponding word character string according to the semantic type of the multi-digit number character; determining the semantic type of a corresponding symbol character in the to-be-processed character sequence according to the second semantic category identifier, and converting the symbol character into a corresponding word character string according to the semantic type of the symbol character; and determining the semantic type of a corresponding letter character in the to-be-processed character sequence according to the third semantic category identifier, and converting the letter character into a corresponding word character string according to the semantic type of the letter character. That is, the semantic type of the corresponding to-be-processed character may be determined first according to the output category Identifier, and then the output category identifier may be converted according to the semantic type.

For example, the output category identifier sequence obtained by processing the to-be-processed text “Federer won the match with a score of 3:1” with a text normalization model is E|E|E|E|E|E|E|E|E|G|E, wherein the to-be-processed character corresponding to the output category identifier G is “:”. The semantic type of the to-be-processed character may be determined as a score type according to the category identifier G, then the category identifier may be converted into “to” corresponding to the score type, while the category identifier E is directly converted into a corresponding to-be-processed character or into a unique normalization result of the to-be-processed character to obtain an output character sequence “Federer|won|the|match|with|a|score|of|three|to|one”; and then the output character sequences are combined to obtain a normalized text “Federer won the match with a score of three to one” of the to-be-processed text.

It should be noted that the specific implementation of segmenting the to-be-processed text and tagging the non-word character having at least two normalization results in the segmentation result according to the present embodiment may also refer to the specific implementation of segmenting the input text to obtain a first segmentation result and tagging the non-word character having at least two normalization results in the first segmentation result according to the method for training a text normalization model above, and such contents will thus not be repeated here.

The method for text normalization provided in the embodiment of the present disclosure includes: first, acquiring a to-be-processed character sequence that is obtained by segmenting a to-be-processed text according to a first preset granularity and tagging a non-word character having at least two normalization results in a segmentation result; inputting the to-be-processed character sequence into a trained text normalization model to obtain an output category identifier sequence; and converting output category identifiers in the output category identifier sequence on the basis of the to-be-processed character sequence to obtain output characters corresponding to the output category identifiers, and combining the output characters in sequence to obtain a normalized text of the to-be-processed text, wherein the text normalization model is trained by: inputting input characters in an input character sequence corresponding to an input text into a recurrent neural network corresponding to a to-be-generated text normalization model successively; classifying each of the input characters with a first preset category identifier by the recurrent neural network with a first preset category identifier to obtain a predicted classification result of the input character sequence with a first preset category identifier; and adjusting a parameter of the recurrent neural network with a first preset category identifier based on the difference between the predicted classification result of the input character sequence with a first preset category identifier and a tagged classification result of a normalized text of the input text with a first preset category identifier, wherein the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier. The method for text normalization does not need to maintain rules, thus avoiding the resource consumption caused by rule maintenance. Moreover, by classifying each character in a to-be-processed text and then determining a normalization result of the character according to the classification result of the character, the method has strong flexibility and high accuracy, and may be applied for converting complex texts.

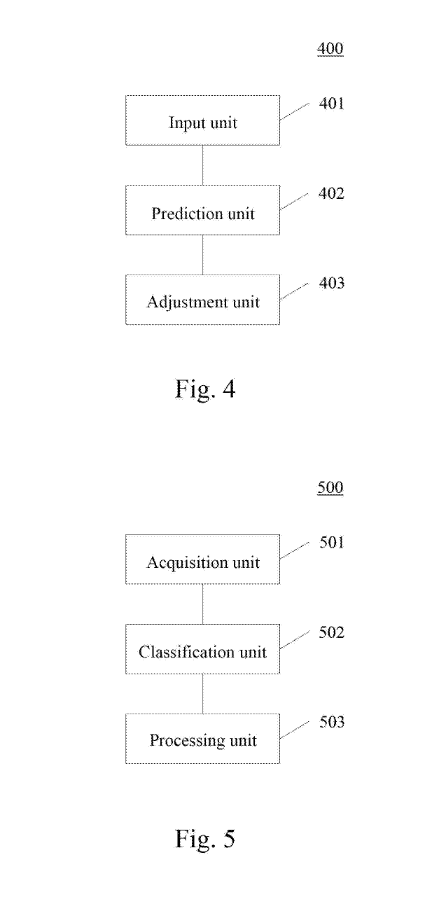

Referring further to FIG. 4, the present disclosure, as an implementation of the method shown in FIG. 2, provides an embodiment of an apparatus for training a text normalization module. The apparatus embodiments are corresponding to the method embodiments shown in FIG. 2, and the apparatus may be specifically applied to various electronic devices.

As shown in FIG. 4, an apparatus 400 for training a text normalization module according to the present embodiment may include an input unit 401, a prediction unit 402, and an adjustment unit 403. The input unit 401 may be configured for inputting input characters in an input character sequence corresponding to an input text into a recurrent neural network corresponding to a to-be-generated text normalization model successively. The input character sequence corresponding to the input text is generated by segmenting the input text according to a first preset granularity to obtain a first segmentation result, and tagging a non-word character having at least two normalization results in the first segmentation result to obtain the input character sequence. The prediction unit 402 may be configured for classifying each of the input characters by the recurrent neural network to obtain a predicted classification result of the input character sequence. The adjustment unit 403 may be configured for adjusting a parameter of the recurrent neural network based on the difference between the predicted classification result of the input character sequence and a tagged classification result of a normalized text of the input text.

In the present embodiment, the input unit 401 may acquire a corresponding input character string sequence obtained by processing the input text, and input the input characters in the acquired input character sequence into the recurrent neural network corresponding to the to-be-generated text normalization model in sequence.

The prediction unit 402 may classify each character in the input character sequence according to the semantic type or pronunciation type thereof. Specifically, when the prediction unit 402 classifies, the input character xₜ of step t and the state of a hidden layer of the recurrent neural network in the previous step may be converted by using a nonlinear activation function in the recurrent neural network to obtain the current state of the hidden layer, and then the current state of the hidden layer may be converted by using the nonlinear conversion function to obtain an output predicted classification result of the input character xₜ.

The adjustment unit 403 may compare a prediction result of the prediction unit 402 with a tagging result of the tagged input text, calculate the difference therebetween, and specifically may construct a loss function on the basis of the comparison result. Then the unit may adjust a parameter in a nonlinear activation function and a parameter in the nonlinear conversion function in the recurrent neural network corresponding to the text normalization model according to the loss function. Specifically, the gradient descent method may be used to calculate the gradient of the loss function with respect to each parameter, and the parameter along the gradient direction may be adjusted according to a set learning rate to obtain an adjusted parameter.

After that, the prediction unit 402 may predict the conversion result of the input text on the basis of the neural network with an adjusted parameter, and provide the predicted classification result for the adjustment unit 403 which may then continue to adjust the parameter. In this way, the parameter of the recurrent neural network is continuously adjusted by the prediction unit 402 and the adjustment unit 403, so that the predicted classification result approaches the tagged classification result, and a trained text normalization model is obtained when the difference between the predicted classification result and the tagged classification result meets a preset convergence condition.

In some embodiments, the non-word character having at least two normalization results in the first segmentation result may include at least one of: a symbol character having at least two normalization results, a multi-digit number character having at least two normalization results, or a letter character having at least two normalization results. At this time, the non-word character having at least two normalization results in the first segmentation result may be tagged by: replacing the symbol character having at least two normalization results in the first segmentation result with a pronunciation type tag of the symbol character, replacing the multi-digit number character having at least two normalization results in the first segmentation result with a tag corresponding to the semantic type of the multi-digit number character and including length information of the multi-digit number character, and replacing the letter character having at least two normalization results in the first segmentation result with a tag corresponding to the semantic type of the letter character.

In some embodiments, the predicted classification result of the input character sequence may include predicted category information of the each of the input characters in the input character sequence; and the tagged classification result of the normalized text of the input text includes tagged category information of each target character in a target character sequence corresponding to the normalized text of the input text.

In a further embodiment, the tagged classification result of the normalized text of the input text may be generated by: segmenting the normalized text of the input text according to a second preset granularity to obtain a second segmentation result, the second segmentation result including at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text; replacing the single word character corresponding to the single word character in the input text, the symbol character corresponding to the symbol character in the input text, and the letter character corresponding to the letter character in the input text in the second segmentation result with a first preset category identifier; replacing the first word character string corresponding to the multi-digit number character in the input text in the second segmentation result with a first semantic category identifier for identifying the semantic type of the corresponding multi-digit number character in the input text; replacing the second word character string corresponding to the symbol character in the input text in the second segmentation result with a second semantic category identifier for identifying the semantic type of the corresponding symbol character in the input text; and replacing the third word character string corresponding to the letter character in the input text with a third semantic category identifier for identifying the semantic type of the corresponding letter character in the input text.

The apparatus 400 for training a text normalization model according to the embodiment of the present disclosure converts special texts possibly having multiple different normalization results in an input text into corresponding type tags for training, thereby solving the problem of difficult rule maintenance and ensuring that a text normalization model obtained by training accurately converts such special texts by: inputting, by an input unit, input characters in an input character sequence corresponding to an input text into a recurrent neural network corresponding to a to-be-generated text normalization model successively, wherein the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier; classifying, by a prediction unit, each of the input characters with a first preset category identifier by the recurrent neural network with a first preset category identifier to obtain a predicted classification result of the input character sequence with a first preset category identifier; and adjusting, by an adjustment unit, a parameter of the recurrent neural network with a first preset category identifier based on the difference between the predicted classification result of the input character sequence with a first preset category identifier and a tagged classification result of a normalized text of the input text with a first preset category identifier.

It should be understood that the units recorded in the apparatus 400 may be corresponding to the steps in the method described in FIG. 2. Therefore, the operations and characteristics described for the method for training a text normalization model are also applicable to the apparatus 400 and the units included therein, and such operations and characteristics will not be repeated here.

Referring further to FIG. 5, the present disclosure, as an implementation of the method shown in FIG. 3, provides an embodiment of an apparatus for text normalization. The apparatus embodiments are corresponding to the method embodiments shown in FIG. 3, and the apparatus may be specifically applied to various electronic devices.

As shown in FIG. 5, an apparatus 500 for text normalization according to the present embodiment may include an acquisition unit 501, a classification unit 502, and a processing unit 503. The acquisition unit 501 may be configured for acquiring a to-be-processed character sequence that is obtained by segmenting a to-be-processed text according to a first preset granularity and tagging a non-word character having at least two normalization results in a segmentation result; the classification unit 502 may be configured for inputting the to-be-processed character sequence into a trained text normalization model to obtain an output category identifier sequence; and the processing unit 503 may be configured for converting output category identifiers in the output category identifier sequence on the basis of the to-be-processed character sequence to obtain output characters corresponding to the output category identifiers, and combining the output characters in sequence to obtain a normalized text of the to-be-processed text. The text normalization model is trained on the basis of the method as described in FIG. 2. Specifically, the text normalization model may be trained by: inputting input characters in an input character sequence corresponding to an input text into a recurrent neural network corresponding to a to-be-generated text normalization model successively; classifying each of the input characters with a first preset category identifier by the recurrent neural network with a first preset category identifier to obtain a predicted classification result of the input character sequence with a first preset category identifier; and adjusting a parameter of the recurrent neural network with a first preset category identifier based on the difference between the predicted classification result of the input character sequence with a first preset category identifier and a tagged classification result of a normalized text of the input text with a first preset category identifier, wherein the input character sequence corresponding to the input text is generated by segmenting the input text with a first preset category identifier according to a first preset granularity to obtain a first segmentation result, and tagging a non-word character having at least two normalization results in the first segmentation result to obtain an input character sequence with a first preset category identifier.

In the present embodiment, the acquisition unit 501 may acquire, by means of an input interface, a to-be-processed character sequence that is obtained by manually segmenting and tagging the to-be-processed text.

In some alternative implementations of the present embodiment, the non-word character having at least two normalization results in the segmentation result may include at least one of: a symbol character having at least two normalization results, a multi-digit number character having at least two normalization results, or a letter character having at least two normalization results. At this time, the non-word character having at least two normalization results in the segmentation result may be tagged by: replacing the symbol character having at least two normalization results in the segmentation result with a pronunciation type tag of the symbol character, replacing the multi-digit number character having at least two normalization results in the segmentation result with a tag corresponding to the semantic type of the multi-digit number character and including length information of the multi-digit number character, and replacing the letter character having at least two normalization results in the segmentation result with a tag corresponding to the semantic type of the letter character.

The processing unit 503 may convert a category identifier in the output category identifier sequence obtained by the classification unit 502, and may specifically replace the category identifier with a corresponding word character. The character sequence obtained by the conversion may then be sequentially combined to form a normalized text of the to-be-processed text.

In some alternative implementations of the present embodiment, the output category identifiers in the output category identifier sequence may include at least one of: a first preset category identifier for identifying the category of an unconverted character, a first semantic category identifier for identifying the semantic type of a multi-digit number character, a second semantic category identifier for identifying the semantic type of a symbol character, or a third semantic category identifier for identifying the semantic type of a letter character. At this time, the processing unit 503 may be further configured for converting output category identifiers in the output category identifier sequence to obtain output characters corresponding to the output category identifiers by: replacing the first preset category identifier with a corresponding to-be-processed character; determining the semantic type of a corresponding multi-digit number character in the to-be-processed character sequence according to the first semantic category identifier, and converting the multi-digit number character into a corresponding word character string according to the semantic type of the multi-digit number character; determining the semantic type of a corresponding symbol character in the to-be-processed character sequence according to the second semantic category identifier, and converting the symbol character into a corresponding word character string according to the semantic type of the symbol character; and determining the semantic type of a corresponding letter character in the to-be-processed character sequence according to the third semantic category identifier, and converting the letter character into a corresponding word character string according to the semantic type of the letter character.

According to the apparatus 500 for text normalization according to the present embodiment of the present disclosure, an acquisition unit acquires a to-be-processed character sequence that is obtained by segmenting a to-be-processed text according to a first preset granularity and tagging a non-word character having at least two normalization results in a segmentation result; then, a classification unit inputs the to-be-processed character sequence into a trained text normalization model to obtain an output category identifier sequence; and finally, output category identifiers in the output category identifier sequence is converted on the basis of the to-be-processed character sequence to obtain output characters corresponding to the output category identifiers, and the output characters are combined in sequence to obtain a normalized text of the to-be-processed text. The text normalization model is trained by: inputting input characters in an input character sequence corresponding to an input text into a recurrent neural network corresponding to a to-be-generated text normalization model successively; classifying each of the input characters by the recurrent neural network to obtain a predicted classification result of the input character sequence; and adjusting a parameter of the recurrent neural network based on the difference between the predicted classification result of the input character sequence and a tagged classification result of a normalized text of the input text, where the input character sequence corresponding to the input text is generated by segmenting the input text according to a first preset granularity to obtain a first segmentation result, and tagging a non-word character having at least two normalization results in the first segmentation result to obtain the input character sequence. The apparatus classifies each character in a to-be-processed text to convert the text correctly according to the classification result, which solves the problems of difficult rule maintenance and large resource consumption. In addition, the apparatus has strong flexibility and high accuracy, and may be applied for converting complex texts.

It should be understood that the units recorded in the apparatus 500 may be corresponding to the steps in the method for text normalization as described in FIG. 3. Therefore, the operations and characteristics described for the method for text normalization are also applicable to the apparatus 500 and the units included therein, and such operations and characteristics will not be repeated here.

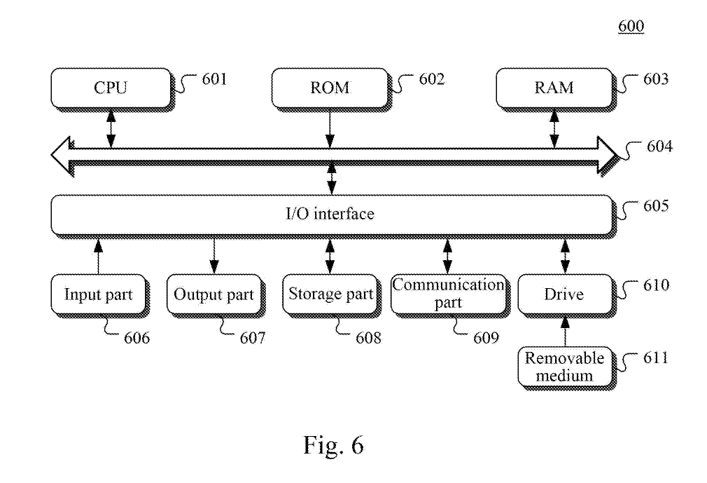

Referring to FIG. 6, a schematic structural diagram of a computer system 600 adapted to implement a terminal device or a server of the embodiments of the present application is shown. The terminal device or server shown in FIG. 6 is merely an example and should not impose any restriction on the function and scope of use of the embodiments of the present application.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 including a cathode ray tube (CRT), a liquid crystal display device (LCD), a speaker etc.; a storage portion 608 including a hard disk and the like; and a communication portion 609 including a network interface card, such as a LAN card and a modem. The communication portion 609 performs communication processes via a network, such as the Internet. A drive 610 is also connected to the I/O interface 605 as required. A removable medium 611, such as a magnetic disk, an optical disk, a magneto-optical disk, and a semiconductor memory, may be installed on the drive 610, to facilitate the retrieval of a computer program from the removable medium 611, and the installation thereof on the storage portion 608 as needed.

In particular, according to embodiments of the present disclosure, the process described above with reference to the flow chart may be implemented in a computer software program. For example, an embodiment of the present disclosure includes a computer program product, which includes a computer program that is tangibly embedded in a machine-readable medium. The computer program includes program codes for executing the method as illustrated in the flow chart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present disclosure. It should be noted that the computer readable medium in the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present application may be implemented by means of software or hardware. The described units or modules may also be provided in a processor, for example, described as: a processor, including an input unit, a prediction unit, and an adjustment unit, where the names of these units or modules do not in some cases constitute a limitation to such units or modules themselves. For example, the input unit may also be described as “a unit for inputting input characters in an input character sequence corresponding to an input text into a recurrent neural network corresponding to a to-be-generated text normalization model successively.”

In another aspect, the present application further provides a non-transitory computer-readable storage medium. The non-transitory computer-readable storage medium may be the non-transitory computer-readable storage medium included in the apparatus in the above described embodiments, or a stand-alone non-transitory computer-readable storage medium not assembled into the apparatus. The non-transitory computer-readable storage medium stores one or more programs. The one or more programs, when executed by a device, cause the device to: input input characters in an input character sequence corresponding to an input text into a recurrent neural network corresponding to a to-be-generated text normalization model successively; classify each of the input characters by the recurrent neural network to obtain a predicted classification result of the input character sequence; and adjust a parameter of the recurrent neural network based on the difference between the predicted classification result of the input character sequence and a tagged classification result of a normalized text of the input text, wherein the input character sequence corresponding to the input text is generated by segmenting the input text according to a first preset granularity to obtain a first segmentation result, and tagging a non-word character having at least two normalization results in the first segmentation result to obtain the input character sequence.

the present application further provides a non-transitory computer-readable storage medium. The non-transitory computer-readable storage medium may be the non-transitory computer-readable storage medium included in the apparatus in the above described embodiments, or a stand-alone non-transitory computer-readable storage medium not assembled into the apparatus. The non-transitory computer-readable storage medium stores one or more programs. The one or more programs, when executed by a device, cause the device to: acquire a to-be-processed character sequence that is obtained by segmenting a to-be-processed text according to a first preset granularity and tag a non-word character having at least two normalization results in a segmentation result; input the to-be-processed character sequence into a trained text normalization model to obtain an output category identifier sequence; and convert output category identifiers in the output category identifier sequence on the basis of the to-be-processed character sequence to obtain output characters corresponding to the output category identifiers, and combine the output characters in sequence to obtain a normalized text of the to-be-processed text, wherein the text normalization model is trained by: inputting input characters in an input character sequence corresponding to an input text into a recurrent neural network corresponding to a to-be-generated text normalization model successively; classifying each of the input characters by the recurrent neural network to obtain a predicted classification result of the input character sequence; and adjusting a parameter of the recurrent neural network based on the difference between the predicted classification result of the input character sequence and a tagged classification result of a normalized text of the input text, wherein the input character sequence corresponding to the input text is generated by segmenting the input text according to a first preset granularity to obtain a first segmentation result, and tagging a non-word character having at least two normalization results in the first segmentation result to obtain the input character sequence.

The above description only provides an explanation of the preferred embodiments of the present application and the technical principles used. It should be appreciated by those skilled in the art that the inventive scope of the present application is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present application are examples.

What is claimed is:

1. A method for training a text normalization model, comprising:
inputting input characters in an input character sequence corresponding to an input text into a recurrent neural network corresponding to a to-be-generated text normalization model successively;
classifying each of the input characters by the recurrent neural network to obtain a predicted classification result of the input character sequence; and
adjusting a parameter of the recurrent neural network based on the difference between the predicted classification result of the input character sequence and a tagged classification result of a normalized text of the input text,
wherein the input character sequence corresponding to the input text is generated by:
segmenting the input text according to a first preset granularity to obtain a first segmentation result; and
tagging a non-word character having at least two normalization results in the first segmentation result to obtain the input character sequence.

2. The method according to claim 1, wherein the non-word character having at least two normalization results in the first segmentation result comprises at least one of: a symbol character having at least two normalization results, a multi-digit number character having at least two normalization results, or a letter character having at least two normalization results;
the non-word character having at least two normalization results in the first segmentation result is tagged by:
replacing the symbol character having at least two normalization results in the first segmentation result with a pronunciation type tag of the symbol character, replacing the multi-digit number character having at least two normalization results in the first segmentation result with a tag corresponding to a semantic type of the multi-digit number character and comprising length information of the multi-digit number character, and replacing the letter character having at least two normalization results in the first segmentation result with a tag corresponding to a semantic type of the letter character.

3. The method according to claim 1, wherein the predicted classification result of the input character sequence comprises predicted category information of the each of the input characters in the input character sequence; and
the tagged classification result of the normalized text of the input text comprises tagged category information of each target character in a target character sequence corresponding to the normalized text of the input text.

4. The method according to claim 3, wherein the tagged classification result of the normalized text of the input text is generated by:
segmenting the normalized text of the input text according to a second preset granularity to obtain a second segmentation result, the second segmentation result comprising at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text;
replacing the single word character corresponding to the single word character in the input text, the symbol character corresponding to the symbol character in the input text, and the letter character corresponding to the letter character in the input text in the second segmentation result with a first preset category identifier;
replacing the first word character string corresponding to the multi-digit number character in the input text in the second segmentation result with a first semantic category identifier for identifying a semantic type of the corresponding multi-digit number character in the input text;
replacing the second word character string corresponding to the symbol character in the input text in the second segmentation result with a second semantic category identifier for identifying a semantic type of the corresponding symbol character in the input text; and
replacing the third word character string corresponding to the letter character in the input text with a third semantic category identifier for identifying a semantic type of the corresponding letter character in the input text.

5. The method according to claim 1, further comprising:
normalizing text by:
acquiring a to-be-processed character sequence that is obtained by segmenting a to-be-processed text according to a first preset granularity and tagging a non-word character having at least two normalization results in a segmentation result;
inputting the to-be-processed character sequence into the trained text normalization model to obtain an output category identifier sequence; and
converting output category identifiers in the output category identifier sequence on the basis of the to-be-processed character sequence to obtain output characters corresponding to the output category identifiers, and combining the output characters in sequence to obtain a normalized text of the to-be-processed text.

6. The method according to claim 5, wherein the non-word character having at least two normalization results in the segmentation result comprises at least one of: a symbol character having at least two normalization results, a multi-digit number character having at least two normalization results, or a letter character having at least two normalization results;
the non-word character having at least two normalization results in the segmentation result is tagged by:
replacing the symbol character having at least two normalization results in the segmentation result with a pronunciation type tag of the symbol character, replacing the multi-digit number character having at least two normalization results in the segmentation result with a tag corresponding to a semantic type of the multi-digit number character and comprising length information of the multi-digit number character, and replacing the letter character having at least two normalization results in the segmentation result with a tag corresponding to a semantic type of the letter character.

7. The method according to claim 6, wherein the output category identifiers in the output category identifier sequence comprise at least one of: a first preset category identifier for identifying the category of an unconverted character, a first semantic category identifier for identifying a semantic type of a multi-digit number character, a second semantic category identifier for identifying a semantic type of a symbol character, or a third semantic category identifier for identifying a semantic type of a letter character;
the converting output category identifiers in the output category identifier sequence on the basis of the to-be-processed character sequence to obtain output characters corresponding to the output category identifiers comprises:
replacing the first preset category identifier with a corresponding to-be-processed character;
determining the semantic type of a corresponding multi-digit number character in the to-be-processed character sequence according to the first semantic category identifier, and converting the multi-digit number character into a corresponding word character string according to the semantic type of the multi-digit number character;
determining the semantic type of a corresponding symbol character in the to-be-processed character sequence according to the second semantic category identifier, and converting the symbol character into a corresponding word character string according to the semantic type of the symbol character; and
determining the semantic type of a corresponding letter character in the to-be-processed character sequence according to the third semantic category identifier, and converting the letter character into a corresponding word character string according to the semantic type of the letter character.

8. An apparatus for training a text normalization model, comprising:
at least one processor; and
a memory storing instructions, the instructions when executed by the at least one processor, cause the at least one processor to perform operations, the operations comprising:
inputting input characters in an input character sequence corresponding to an input text into a recurrent neural network corresponding to a to-be-generated text normalization model successively;
classifying each of the input characters by the recurrent neural network to obtain a predicted classification result of the input character sequence; and
adjusting a parameter of the recurrent neural network based on the difference between the predicted classification result of the input character sequence and a tagged classification result of a normalized text of the input text,
wherein the input character sequence corresponding to the input text is generated by:
segmenting the input text according to a first preset granularity to obtain a first segmentation result; and
tagging a non-word character having at least two normalization results in the first segmentation result to obtain the input character sequence.

9. The apparatus according to claim 8, wherein the non-word character having at least two normalization results in the first segmentation result comprises at least one of: a symbol character having at least two normalization results, a multi-digit number character having at least two normalization results, or a letter character having at least two normalization results;
the non-word character having at least two normalization results in the first segmentation result is tagged by:
replacing the symbol character having at least two normalization results in the first segmentation result with a pronunciation type tag of the symbol character, replacing the multi-digit number character having at least two normalization results in the first segmentation result with a tag corresponding to a semantic type of the multi-digit number character and comprising length information of the multi-digit number character, and replacing the letter character having at least two normalization results in the first segmentation result with a tag corresponding to a semantic type of the letter character.

10. The apparatus according to claim 8, wherein the predicted classification result of the input character sequence comprises predicted category information of the each of the input characters in the input character sequence; and
the tagged classification result of the normalized text of the input text comprises tagged category information of each target character in a target character sequence corresponding to the normalized text of the input text.

11. The apparatus according to claim 10, wherein the tagged classification result of the normalized text of the input text is generated by:
segmenting the normalized text of the input text according to a second preset granularity to obtain a second segmentation result, the second segmentation result comprising at least one of: a single word character corresponding to a single word character in the input text, a first word character string corresponding to a multi-digit number character in the input text, a second word character string or a symbol character corresponding to a symbol character in the input text, or a third word character string or a letter character corresponding to a letter character in the input text;
replacing the single word character corresponding to the single word character in the input text, the symbol character corresponding to the symbol character in the input text, and the letter character corresponding to the letter character in the input text in the second segmentation result with a first preset category identifier;
replacing the first word character string corresponding to the multi-digit number character in the input text in the second segmentation result with a first semantic category identifier for identifying a semantic type of the corresponding multi-digit number character in the input text;
replacing the second word character string corresponding to the symbol character in the input text in the second segmentation result with a second semantic category identifier for identifying a semantic type of the corresponding symbol character in the input text; and
replacing the third word character string corresponding to the letter character in the input text with a third semantic category identifier for identifying a semantic type of the corresponding letter character in the input text.

12. The apparatus according to claim 8 wherein the instructions, when executed by the at least one processor, cause the at least one processor to perform operations, the operations comprising:
normalizing text by:
acquiring a to-be-processed character sequence that is obtained by segmenting a to-be-processed text according to a first preset granularity and tagging a non-word character having at least two normalization results in a segmentation result;
inputting the to-be-processed character sequence into the trained text normalization model to obtain an output category identifier sequence; and
converting output category identifiers in the output category identifier sequence on the basis of the to-be-processed character sequence to obtain output characters corresponding to the output category identifiers, and combining the output characters in sequence to obtain a normalized text of the to-be-processed text.

13. The apparatus according to claim 12, wherein the non-word character having at least two normalization results in the segmentation result comprises at least one of: a symbol character having at least two normalization results, a multi-digit number character having at least two normalization results, or a letter character having at least two normalization results;
the non-word character having at least two normalization results in the segmentation result is tagged by:
replacing the symbol character having at least two normalization results in the segmentation result with a pronunciation type tag of the symbol character, replacing the multi-digit number character having at least two normalization results in the segmentation result with a tag corresponding to a semantic type of the multi-digit number character and comprising length information of the multi-digit number character, and replacing the letter character having at least two normalization results in the segmentation result with a tag corresponding to a semantic type of the letter character.

14. The apparatus according to claim 13, wherein the output category identifiers in the output category identifier sequence comprise at least one of: a first preset category identifier for identifying the category of an unconverted character, a first semantic category identifier for identifying a semantic type of a multi-digit number character, a second semantic category identifier for identifying a semantic type of a symbol character, or a third semantic category identifier for identifying a semantic type of a letter character;
the at least one processor is further configured for converting output category identifiers in the output category identifier sequence on the basis of the to-be-processed character sequence to obtain output characters corresponding to the output category identifiers by:
replacing the first preset category identifier with a corresponding to-be-processed character;
determining the semantic type of a corresponding multi-digit number character in the to-be-processed character sequence according to the first semantic category identifier, and converting the multi-digit number character into a corresponding word character string according to the semantic type of the multi-digit number character;
determining the semantic type of a corresponding symbol character in the to-be-processed character sequence according to the second semantic category identifier, and converting the symbol character into a corresponding word character string according to the semantic type of the symbol character; and
determining the semantic type of a corresponding letter character in the to-be-processed character sequence according to the third semantic category identifier, and converting the letter character into a corresponding word character string according to the semantic type of the letter character.

15. A non-transitory computer-readable storage medium storing a computer program, the computer program when executed by one or more processors, causes the one or more processors to perform operations, the operations comprising:
inputting input characters in an input character sequence corresponding to an input text into a recurrent neural network corresponding to a to-be-generated text normalization model successively;
classifying each of the input characters by the recurrent neural network to obtain a predicted classification result of the input character sequence; and
adjusting a parameter of the recurrent neural network based on the difference between the predicted classification result of the input character sequence and a tagged classification result of a normalized text of the input text,
wherein the input character sequence corresponding to the input text is generated by:
segmenting the input text according to a first preset granularity to obtain a first segmentation result; and
tagging a non-word character having at least two normalization results in the first segmentation result to obtain the input character sequence.

16. The non-transitory computer-readable storage medium according to claim 15, wherein the operations further comprise:
acquiring a to-be-processed character sequence that is obtained by segmenting a to-be-processed text according to a first preset granularity and tagging a non-word character having at least two normalization results in a segmentation result;
inputting the to-be-processed character sequence into the trained text normalization model to obtain an output category identifier sequence; and
converting output category identifiers in the output category identifier sequence on the basis of the to-be-processed character sequence to obtain output characters corresponding to the output category identifiers, and combining the output characters in sequence to obtain a normalized text of the to-be-processed text.
